(19) United States
(12) Patent Application Publication
(10) Pub. No.: US 2024/0362747 A1
(43) Pub. Date: Oct. 31, 2024

(54) METHODS FOR GENERATING IMAGE SUPER-RESOLUTION DATA SET, IMAGE SUPER-RESOLUTION MODEL AND TRAINING METHOD

(71) Applicant: BEIJING WEILING TIMES TECHNOLOGY CO., LTD., Beijing (CN)

(72) Inventor: Jianjun GUO, Beijing (CN)

(21) Appl. No.: 18/535,223

(22) Filed: Dec. 11, 2023

Related U.S. Application Data
(63) Continuation of application No. PCT/CN2023/117704, filed on Sep. 8, 2023.

(30) Foreign Application Priority Data
Apr. 26, 2023 (CN) 202310463689.0

(51) Int. Cl. G06T 3/4053; G06N 20/00

(52) U.S. Cl. CPC G06T 3/4053; G06N 20/00

(57) ABSTRACT

A method for generating an image super-resolution data set, an image super-resolution model and a training method. The method for generating an image super-resolution data set comprises steps of: S101: constructing a high-resolution image set; S102: performing image blind degradation processing on all high-resolution images HR1 to obtain an LR1-HR1 data set; S103: training a first model with the LR1-HR1 data set to obtain a model parameter of the first model and saving the model parameter; S104: constructing a low-resolution image set; and S105: inputting all low-resolution images LR2 into the first model to obtain an LR2-SR2 data set after inference by the first model. Using the LR2-SR2 data set of the present disclosure, training can be performed on a model with a relatively simple structure, the learning speed is fast, and the trained model has strong generalization ability.

### FIELD

The present disclosure relates to the field of image super-resolution, specifically to a method for generating an image super-resolution data set, a model training method, and an image super-resolution model.

### BACKGROUND

Image super-resolution (SR) is a technology that restores low-resolution input to high-resolution (HR) output to improve display quality. Image super-resolution is divided into cloud super-resolution and end-side super-resolution. Cloud super-resolution is to perform image super-resolution on the server, and end-side super-resolution is to perform image super-resolution on the terminal device. There are various reasons for the degradation of image quality in the real world, so data sets generated using specific degradation methods often perform poorly when processing real images. In order to handle the super-resolution task of low-resolution images caused by various reasons and improve the generalization ability of the super-resolution model, it is necessary to use different degradation methods to simulate different low-resolution images to train the super-resolution model. However, for the super-resolution model installed on the end side, due to the hardware limitations of the end side, the model structure of the end-side super-resolution model is usually simpler than that of the cloud super-resolution model. Therefore, when training with the above-mentioned low-resolution images and corresponding high-resolution images as training sets, there are problems such as poor model training results and slow learning speed.

Patent document CN112488924A discloses an image super-resolution model training method, comprising: acquiring low-resolution images and their corresponding real high-resolution images and real visible light images to form a training sample set; inputting the low-resolution images in the training sample set into a preset image super-resolution model to obtain an alternative high-resolution image; performing image mode conversion on the alternative high-resolution image and the real high-resolution image respectively to obtain a first visible light image and a second visible light image; constructing a loss function based on the difference between the first visible light image and the second visible light image and the real visible light image and the difference between the alternative high-resolution image and the real high-resolution image; and, based on the loss function, performing model training on the preset image super-resolution model to obtain a trained preset image super-resolution model.

In the prior art, no consideration is given to constructing training images with different causes of degradation, and it fails to output super-resolution images with good effects from low-resolution images with different causes of degradation when processing real-world images, with poor generalization ability of the model.

### SUMMARY

The present disclosure aims to solve the problems of poor model training effect and slow learning speed when training on the end-side model to improve the model generalization ability, and provides a training set of low-resolution images and corresponding high-resolution images suitable for a simple structure model, which has good training effect, fast learning speed, strong generalization ability of the model after training, a model training method based on the above training set, and an image super-resolution model obtained by training.

In view of the above-mentioned limitations, the present disclosure proposes a method for generating an image super-resolution data set, comprising steps of:
S101: constructing a high-resolution image set;
S102: performing image blind degradation processing on high-resolution image HR1 in the high-resolution image set to obtain the corresponding low-resolution image LR1 and thereby an LR1-HR1 data pair, and performing image blind degradation processing on all high-resolution images HR1 in the high-resolution image set to obtain an LR1-HR1 data set;
S103: training a first model with the LR1-HR1 data set to obtain a model parameter of the first model and saving the model parameter, wherein the first model is an image super-resolution model;
S104: constructing a low-resolution image set; and
S105: inputting low-resolution image LR2 in the low-resolution image set into the first model with the model parameter to obtain super-resolution image SR2 and thereby an LR2-SR2 data pair, and inputting all low-resolution images LR2 in the low-resolution image set into the first model with the model parameter to obtain an LR2-SR2 data set.

Further, step S103 comprises:
S1031: inputting the low-resolution image LR1 into the first model, and the first model outputs super-resolution image SR1;
S1032: calculating a loss function using the high-resolution image HR1 and the super-resolution image SR1;
S1033: in the case where the loss function is less than a first preset threshold, saving the model parameter; and
S1034: repeating steps S1031 to S1033 for each LR1-HR1 data pair in the training set to obtain the model parameter of the first model.

Further, the image blind degradation processing, based on a random selection method, comprises performing on the high-resolution image HR1 any one or more of:
blurring operation: based on the random selection method, selecting one or both of Gaussian blur and Sinc filter blur for operation;
scaling operation: based on the random selection method, selecting one or more of bilinear interpolation, bicubic interpolation, and regional interpolation for operation;
noise superposition operation: based on the random selection method, selecting one or both of Gaussian noise and Poisson noise for operation; and
image compression operation: compressing the image with a compression factor of 30%-95%; and
wherein, the image blind degradation processing is performed once, or the image blind degradation processing is iteratively performed twice.

Further, the random selection method comprises randomly giving a random score between 0 and 1 to all options, and in the case where the random score of an option is less than a second preset threshold, the operation will not be performed; normalizing all random scores greater than or equal to the second preset threshold as a weight of the corresponding option, performing an operation corresponding to the options with the random score greater than or equal to the second preset threshold, and performing weighted calculation on the performed results of all options according to the weight to obtain an output result.

Further, in step S103, the first model includes ESRGAN model, SwinIR model, and HAT model; and training the ESRGAN model, SwinIR model, and HAT model respectively with the LR1-HR1 data set and saving the model parameter of each model; and

in step S105, inputting low-resolution image LR2 into the ESRGAN model, SwinIR model, and HAT model respectively, and performing weighted fusion of the obtained results according to a preset weight to obtain the super-resolution image SR2;
wherein, the preset weight is 0.2 for the ESRGAN model, 0.4 for the SwinIR model, and 0.4 for the HAT model.

Further, in steps S101-S102, the LR1-HR1 data set comprises n types of sub-training sets;
in step S103, training the first model comprises training the first model with n types of sub-training sets respectively to obtain n groups of sub-model parameter; and
in step S105, for the k groups of sub-model parameter, selecting one group of sub-model parameter in sequence as the model parameter of the first model, inputting the low-resolution image LR2 to obtain an output result, and performing weighted fusion of all output results according to a preset weight to obtain the super-resolution image SR2.

Further, in steps S101-S102, the LR1-HR1 data set comprises one basic training set and k types of sub-training sets;
in step S103, training the first model with the basic training set to obtain a basic model parameter, and
training the first model with the basic model parameter with k types of sub-training sets to obtain k groups of sub-model parameter; and
in step S105, for the k groups of sub-model parameter, selecting one group of sub-model parameter in sequence as the model parameter of the first model, inputting the low-resolution image LR2 to obtain an output result, and performing weighted fusion of all output results according to a preset weight to obtain the super-resolution image SR2. An image super-resolution model training method, comprising training a second model with the LR2-SR2 data set obtained by the above method, wherein the second model is an image super-resolution model, and the training methods comprises steps of:

S201: inputting the LR2 image into the second model, and the second model outputs SR2′ image;
S202: calculating a loss function using the super-resolution image SR2 and the super-resolution image SR2′, and in the case where the loss function is less than a third preset threshold, saving the model parameter; and
S203: repeating steps S201 to S202 for each LR2-SR2 data pair in the LR2-SR2 data set to obtain the model parameter of the second model.

Further, the loss function is calculated by:
calculating L1 loss function, GAN loss function, and perceptual loss function respectively; and
performing weighted calculation on the above calculated results according to the preset weight to obtain the loss function.

An image super-resolution model, obtained by training the second model by the above method, wherein the second model is an ECBSR model.

Compared with the prior art, the present disclosure has the following advantages:

The method for generating an image super-resolution data set in one aspect of the present disclosure uses an image blind degradation processing method to obtain a blindly degraded high and low resolution image LR1-HR1 data set as a training set for a first model, in which the blindly degraded images are used to simulate the reduction of image resolution caused by different causes in the real world, so that the first model can learn strong generalization ability, meaning that it has good results when processing low-resolution images caused by various degradation reasons in the real world. The trained first model is used to perform inference on the low-resolution image LR2 to obtain an LR2-SR2 data set, and the LR2-SR2 data set is used for training of the model to be trained. Even if the structure of the model to be trained is relatively simple, it can quickly approach the first model through knowledge transfer, thereby quickly learning the generalization ability of the first model.

The model training method in one aspect of the present disclosure uses the LR2-SR2 data set obtained by performing inference on the low-resolution image LR2 using the first model to train a second model. The second model can quickly approach the first model through knowledge transfer, thereby quickly learning the generalization ability of the first model.

The image super-resolution model in one aspect of the present disclosure uses the LR2-SR2 data set obtained by performing inference on the low-resolution image LR2 using the first model to train a second model. Even if the structure of the second model is relatively simple, the second model can quickly approach the first model, thereby quickly learning the generalization ability of the first model. The trained second model has strong generalization ability, so it can use a smaller model structure to deal with low-resolution image problems caused by various reasons in real situations, repair and perform super-resolution on the above images with good super-resolution results.

### BRIEF DESCRIPTION OF DRAWINGS

FIG. 1 is a flow chart of the method for generating an image super-resolution data set according to an embodiment of the present disclosure.

FIG. 2 is a flow chart of step S103 in the method for generating an image super-resolution data set according to an embodiment of the present disclosure.

FIG. 3 is a flow chart of a super-resolution model training method according to an embodiment of the present disclosure.

FIG. 4 is a schematic diagram of image blind degradation processing according to an embodiment of the present disclosure.

### DETAILED DESCRIPTION

In order to make the purpose, technical solutions and advantages of the present disclosure clearer, the present disclosure will be described in further detail below. However, it should be understood that the description here is only used to explain the present disclosure and is not used to limit the scope of the present disclosure.

Unless otherwise defined, all technical and scientific terms used herein have the same meanings as commonly understood by those skilled in the technical field of the present disclosure. The terms used herein in the specification of the present disclosure are for the purpose of describing specific examples only and are not intended to limit the present disclosure. For the characterization means involved herein, the relevant descriptions in the prior art could be referred to, and will not be described again herein.

In order to further understand the present disclosure, the present disclosure will be further described in detail below in conjunction with the best embodiments.

### Example 1

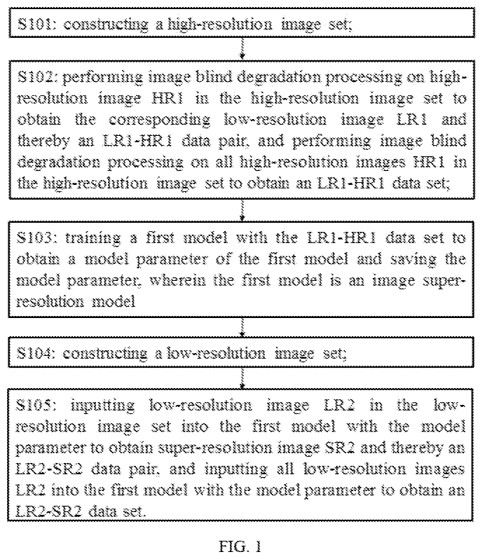

As shown in FIG. 1, a method for generating an image super-resolution data set comprises steps of:
S101: constructing a high-resolution image set;
S102: performing image blind degradation processing on high-resolution image HR1 in the high-resolution image set to obtain the corresponding low-resolution image LR1 and thereby an LR1-HR1 data pair, and performing image blind degradation processing on all high-resolution images HR1 to obtain an LR1-HR1 data set;
S103: training a first model with the LR1-HR1 data set to obtain a model parameter of the first model and saving the model parameter, wherein the first model is an image super-resolution model;
S104: constructing a low-resolution image set; and
S105: inputting low-resolution image LR2 in the low-resolution image set into the first model with the model parameter to obtain super-resolution image SR2 and thereby an LR2-SR2 data pair, and inputting all low-resolution images LR2 into the first model with the model parameter to obtain an LR2-SR2 data set.

When training a super-resolution model, the method for generating high- and low-resolution data pairs of a training set usually uses high-resolution images for degradation. Correlated degradation methods generally assume a predefined degradation process from high-resolution images to low-resolution images, but this method is difficult to hold for real images with complex degradation types. In order to solve the above problems, the blind degradation method is developed. That is, using an uncertain degradation process to complete the process from high-resolution images to low-resolution images. Using the training set generated by this blind degradation method can enable the model to learn strong generalization ability, so that it can better handle real images with complex degradation types. However, the training set generated by this blind degradation method requires high model structure and hardware computing power when training. Therefore, the first model can have a complex model structure, so it can quickly learn strong generalization ability through the blindly degraded training set. After learning through the first model, the LR2-SR2 data set generated using the real low-resolution image LR2 through the inference of the first model is used as a training set for a model with a simple structure to learn, making the inference effect of the model with the simple structure approach that of the model with the complex structure and strong learning ability, which realizes knowledge transfer from a complex model to a simple model. Therefore, the training set has high training efficiency, speed and good effect, and is suitable for training models with simple structure. The blind degradation method can be a degradation method based on the CMDSR framework, or an adaptive learning degradation method based on the CycleGAN framework, etc.

The first model is an image super-resolution model, including but not limited to ESRGAN model, SwinIR model, HAT model, etc.

By using an image blind degradation processing method, a blindly degraded high and low resolution image LR1-HR1 data set is obtained as a training set for a first model. The blindly degraded images are used to simulate the reduction of image resolution caused by different causes in the real world, so that the first model can learn strong generalization ability, meaning that it has good results when processing low-resolution images caused by various degradation reasons in the real world. The trained first model is used to perform inference on the low-resolution image LR2 to obtain an LR2-SR2 data set, and the LR2-SR2 data set is used for training of the model to be trained. Even if the structure of the model to be trained is relatively simple, it can quickly approach the first model through knowledge transfer, thereby quickly learning the generalization ability of the first model.

### Example 2

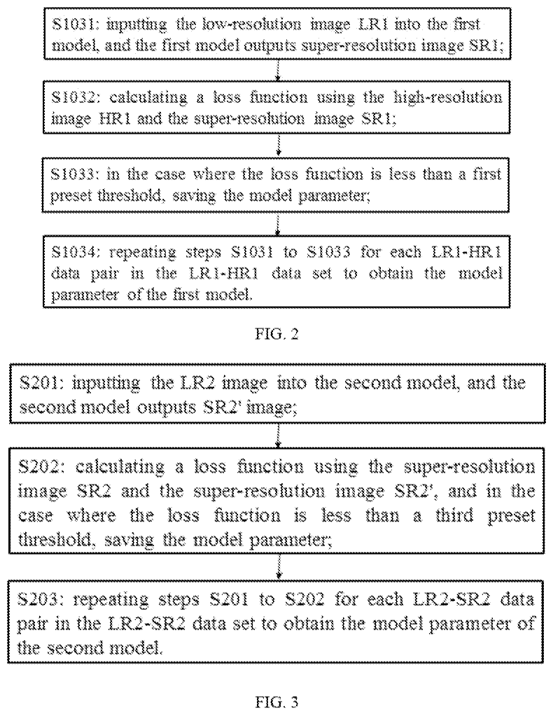

As shown in FIGS. 1-2, on the basis of Example 1, further, steps S103 comprises:
S1031: inputting the low-resolution image LR1 into the first model, and the first model outputs super-resolution image SR1;
S1032: calculating a loss function using the high-resolution image HR1 and the super-resolution image SR1;
S1033: in the case where the loss function is less than a first preset threshold, saving the model parameter; and
S1034: repeating steps S1031 to S1033 for each LR1-HR1 data pair in the training set to obtain the model parameter of the first model.

The first preset threshold is 0.01-0.05.

Further, the image blind degradation processing, based on a random selection method, comprises performing any one or more of the following operations on the high-resolution image HR1:
blurring operation: based on the random selection method, selecting one or both of Gaussian blur and Sinc filter blur for operation;
scaling operation: based on the random selection method, selecting one or more of bilinear interpolation, bicubic interpolation, and regional interpolation for operation;
noise superposition operation: based on the random selection method, selecting one or both of Gaussian noise and Poisson noise for operation; and
image compression operation: compressing the image with a compression factor of 30%-95%; and
wherein, the image blind degradation processing is performed once, or the image blind degradation processing is iteratively performed twice.

The Sinc filter is an ideal low-pass filter used to filter the high-frequency part of a signal from the spectrum. Its design is based on a Sinc function, sinc(t)=sin (πt)/πt, where t represents time. The Sinc function has a very smooth frequency response in the frequency domain, but due to its infinite time domain response, it cannot be used directly in practical applications.

The implementation of the Sinc filter is by defining the filter coefficients in the form of a Sinc function in the frequency domain, and by discretizing these coefficients to obtain the time domain response of the filter. In filter design, filter performance can be controlled by adjusting parameters such as cutoff frequency and filter size.

By adding Sinc filtering, the Sinc filter increases the artifacts by setting different factors to simulate the ringing and overshoot artifact phenomena, thereby removing the oscillation artifacts in the image after training.

Gaussian blur is also known as Gaussian smoothing. The Gaussian blur process of an image is to convolve the image with a normal distribution. The value of the original pixel has the largest Gaussian distribution value and the largest weight. As the distance between adjacent pixels becomes farther and farther away from the original pixel, its weight becomes smaller and smaller. The mathematical expression of the normal distribution is used in Gaussian blur.

The Sinc filter is an ideal electronic filter that removes all signal components above a given bandwidth and only retains low-frequency signals. In the field of digital signals, the normalized Sinc function is defined as:

$$Sin c ( x ) = \frac{sin ( π x )}{π x}$$

Bilinear interpolation is performed by first using linear interpolation in one direction and then using linear interpolation in the other direction. Bilinear interpolation uses 4 pixels to calculate the value of one pixel.

Bicubic interpolation uses 16 surrounding pixels to calculate the value of one pixel. Compared with bilinear interpolation, the only difference is that bicubic interpolation has more complex interpolation formula and the pixels are smoothed during the process. In actual use, for example but not limited to, the bicubic interpolation method based on a BiCubic basis function can be used.

Regional interpolation refers to the reaggregation of data from one set of faces (source faces) to another set of faces (target faces).

Gaussian noise refers to a type of noise whose probability density function obeys Gaussian distribution (i.e. normal distribution). It is usually sensor noise caused by poor lighting and high temperature. Adding Gaussian noise to the image can simulate the noise caused by the above reasons.

Poisson Noise is noise whose probability density obeys the Poisson distribution.

Image compression is a method of compressing images based on image compression algorithms, including but not limited to lossy compression such as JPEG and JP2, and lossless compression such as TIFF, PNG, and GIF.

Compression factor=file size after compression/file size before compression.

In each image compression operation, a random number between 30% and 95% is randomly selected as the compression factor.

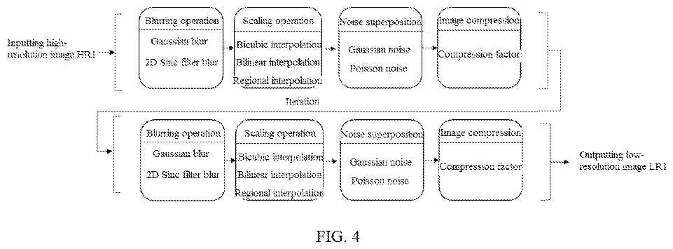

The image blind degradation processing is iteratively performed twice, as shown in FIG. 4, which means that the result of the first image blind degradation processing is brought into the second blind degradation process as input.

In the prior art, an unknown degradation kernel is used to generate a blind degradation data set. Usually a continuously modified degradation kernel is used, and there is no fixed degradation kernel in the process, so it can be called blind degradation. However, the continuous modification of the degradation kernel will lead to a large amount of calculation. The image blind degradation processing method used in the present disclosure uses random selection to simulate the causes of degradation in the real world, and can achieve blind degradation processing with less calculation.

Further, the random selection method comprises randomly giving a random score between 0 and 1 to all options, and in the case where the random score of an option is less than a second preset threshold, the operation will not be performed; normalizing all random scores greater than or equal to the second preset threshold as a weight of the corresponding option, performing an operation corresponding to the options with the random score greater than or equal to the second preset threshold, and performing weighted calculation on the performed results of all options according to the weight to obtain an output result.

The normalization refers to redistributing all random scores greater than or equal to the second preset threshold so that their sum is equal to 1. For example, the second preset threshold is 0.7, and the scores greater than or equal to 0.7 are [0.8, 0.9]. After normalization, they are converted to [0.8/1.7, 0.9/1.7]. The operation will not be performed on other options corresponding to a score less than 0.7.

The weighted calculation on the performed results of all options according to the weight means that the corresponding output values of all options are multiplied by the weight of the option and then superimposed. The corresponding output value refers to the position number of the output value (according to the representation method, such as the row and column number of a matrix, etc.). The following “weighted calculation” concepts are all the same.

Through the above random selection method and the setting of the second preset threshold, the causes of degradation can be randomly simulated and blind degradation of the image can be achieved. The second preset threshold is 0.4-0.8.

The data set generated by the above blind degradation can enhance the generalization ability, expression ability and image reconstruction accuracy of the first model.

Further, in step S103, the first model includes ESRGAN model, SwinIR model, and HAT model; and training the ESRGAN model, SwinIR model, and HAT model respectively with the LR1-HR1 data set and saving the model parameter of each model; and
in step S105, inputting low-resolution image LR2 into the ESRGAN model, SwinIR model, and HAT model respectively, and performing weighted fusion of the obtained results according to a preset weight to obtain the super-resolution image SR2;
wherein, the preset weight is 0.2 for the ESRGAN model, 0.4 for the SwinIR model, and 0.4 for the HAT model.

The weighted fusion refers to multiplying the predicted values of the components with the same sequence number (position) output by each model by the corresponding weights and then adding them together. The following “weighted fusion” is the same.

The ESRGAN model has a SRResNet network structure and includes one or more residual dense blocks (RRDBs).

The Swin IR model is composed of a shallow feature extraction block, a deep feature extraction block, and a reconstruction block.

The shallow feature extraction block uses one or more convolutional layers.

The deep feature extraction block includes one or more residual Swin Transformer blocks (RSTBs). A convolutional layer is connected after all RSTBs, and a residual connection is connected after the convolutional layer.

The RSTB includes one or more STLs (Swin transformer layers). A convolutional layer is connected after all STLs, and a residual connection is connected after the convolutional layer.

The reconstruction block fuses the features obtained by the shallow feature extraction block and the deep feature extraction block to perform image reconstruction.

The HAT model includes one or more RSTBs and one or more residual hybrid attention modules.

The residual hybrid attention module includes one or more hybrid attention blocks (HABs). One or more channel attention blocks are connected after all the hybrid attention blocks, a convolutional layer is connected after all the channel attention blocks, and a residual connection is connected after the convolutional layer.

The channel attention block includes:
Convolution module, including 1 convolution layer, 1 activation function, and 1 convolution layer; and
Residual module: including 1 global pooling layer, 1 convolution layer, 1 activation function, and 1 convolution layer.

The hybrid attention block includes a channel attention block (CAB) and a shifted window-based self-attention layer (SW-MSA) added based on the STL.

The RSTB includes one or more STLs (Swin transformer layers). A convolutional layer is connected after all STLs, and a residual connection is connected after the convolutional layer.

A residual connection is drawn between the convolution module and the residual module, and the residual connection is connected after the residual module.

The possible structure of the above model can be adjusted according to needs, such as increasing or decreasing a certain layer, increasing or decreasing the number of layers, etc., as long as the adjustment is within the framework of the basic model.

The ESRGAN model is mainly good at solving the problem of detail blur and artifacts.

The Swin IR model has stronger local representation capabilities and can use less information to achieve higher performance. It can restore high-frequency details, reduce blur effects, and produce sharp and natural edges.

The HAT model can restore more and clearer details, and HAT has significant advantages in situations where there are many repeated textures. In terms of text recovery, HAT can also restore clearer text edges than other methods.

In the above, the first model is formed by a weighted fusion of one or more of the ESRGAN model, Swin IR model, and HAT model.

By fusing the above multiple blind super-resolution large models with complex structures, and utilizing the differences in learning capabilities and feature expressions of different super-resolution models, the fusion of diverse semantic information are achieved and more accurate inference results are thus obtained.

In steps S101-S102, the obtained LR1-HR1 data set comprises n types of sub-training sets;
in step S103, training the first model comprises training the first model with n types of sub-training sets respectively to obtain n groups of sub-model parameter; and
in step S105, for the k groups of sub-model parameter, selecting one group of sub-model parameter in sequence as the model parameter of the first model, inputting the low-resolution image LR2 to obtain an output result, and performing weighted fusion of all output results according to a preset weight to obtain the super-resolution image SR2.

n types of sub-training sets refer to training sets for a certain type of features, such as specific training sets for processing faces in portraits, specific training sets for processing text, etc. According to application needs, they are not limited to the above types. The first model is trained with the specific type of training set classified above, and the trained first model can have good processing effects in this field. After the first model is trained with a specific type of training set, the model parameters corresponding to that type are obtained, which are called sub-model parameters.

Therefore, in the above, the first model obtains multiple model parameters after being trained with multiple sub-training sets. When inference is performed on the first model, weighted fusion of the output results corresponding to different sub-model parameters is performed to obtain the output of the first model.

One or more sub-model parameters are selected as needed, and weighted fusion of the results of different sub-model parameters is performed to process certain specific features with better results. For example, after weighted fusion of the results using sub-model parameters trained for portrait images and using sub-model parameters trained for text images, the image with both portrait and text can be processed with good super-resolution effects. n is the number of types that need to be trained. n is an integer, n=2-6.

Further,
in steps S101-S102, the obtained LR1-HR1 data set comprises one basic training set and k types of sub-training sets;
in step S103, training the first model with the basic training set to obtain a basic model parameter, and
training the first model with the basic model parameter with k types of sub-training sets to obtain k groups of sub-model parameter, wherein k=2-6.

In step S105, for the k groups of sub-model parameter, selecting one group of sub-model parameter in sequence as the model parameter of the first model, inputting the low-resolution image LR2 to obtain an output result, and fusing all output results according to a preset weight to obtain the super-resolution image SR2.

The basic training set is a training set with various types of features, so that the model can achieve a certain level of output effect when performing super-resolution inference after training. The sub-training set refers to a training set for a certain type of features, such as a specific training set for processing faces in portraits, a specific training set for processing text, etc. According to application needs, they are not limited to the above types. The first model is trained with the specific type of training set classified above, and the trained first model can have good processing effects in this field.

The basic model obtained after training the first model with the basic training set refers to the first model with basic model parameters obtained after training with the basic training set. Further training of the above model using a specific type of sub-training set can enable the first model to quickly learn in this field and achieve good results, thereby shortening the learning time and improving learning efficiency. This process is also called fine-tuning of the model, which is a training method to quickly train the model to adapt to tasks in different fields.

One or more sub-training sets can be selected as needed to train the basic model respectively. After the training is completed, multiple sets of corresponding sub-model parameters are obtained, and then weighted fusion of the output results of different sub-model parameters is performed, which can achieve good results in processing specific tasks and shorten the training time.

The fusion of the output results of the above-mentioned different models, the fusion of the output results during inference after training with the classified training set, and further training of specific classifications based on the basic model, fine-tuning of the model and the fusion of the output results of the models (with different model parameters) obtained by the above classification training during inference are all the optimization method for the model, which can improve the inference quality of the model and make the inferred super-resolution image closer to the real high-resolution image. The above three optimization methods can be used in combination as needed, or can be used alone, which can increase the accuracy of the output results of the super-resolution model.

Further, the loss function is calculated by:
calculating L1 loss function, GAN loss function, and perceptual loss function respectively; and
performing weighted calculation on the above calculated results according to the preset weight to obtain the loss function.

The L1 loss function, also known as the mean absolute error (MAE), refers to the average value of the absolute difference between the model predicted value f (x) and the true value y. The formula is:

$$MAE = \frac{{\sum }_{i = 1}^{n} \vert f ( {x}_{i} ) - {y}_{i} \vert}{n}$$

where f(xᵢ) and yᵢ represent the predicted value and corresponding true value of the i-th sample respectively, and n is the number of samples.

The perceptual loss function is to input the output image I and the original high-resolution image I_{HR} into a differentiable function, and the formula of the perceptual loss function is:

$$Lp = {‖ ∅ ( I ) - ∅ ( {I}_{HR} ) ‖}_{2}^{2}$$

The GAN loss function formula is:

$${min}_{G} {max}_{D} V ( D , G ) = {𝔼}_{x ∼ {p}_{data} ( x )} [ log D ( x ) ] + {𝔼}_{z ∼ {p}_{z} ( z )} [ log ( 1 - D ( G ( z ) ) ) ]$$

where the GAN loss function is composed of two parts: the discriminant network and the generative network. In V(D,G), V is the symbol representing a loss function, D represents the discriminant network, and G represents the generative network.

### Example 3

As shown in FIG. 3, on the basis of Example 1 or 2, a model training method comprises training a second model with the LR2-SR2 data set obtained by the method described in Example 1 or 2, wherein the second model is an image super-resolution model, and the training methods comprises steps of:
S201: inputting the LR2 image into the second model, and the second model outputs SR2′ image;
S202: calculating a loss function using the super-resolution image SR2 and the super-resolution image SR2′, and in the case where the loss function is less than a third preset threshold, saving the model parameter; and
S203: repeating steps S201 to S202 for each LR2-SR2 data pair in the LR2-SR2 data set to obtain the model parameter of the second model.

Further, the loss function is calculated by:
calculating L1 loss function, GAN loss function, and perceptual loss function respectively; and
performing weighted calculation on the above calculated results according to the preset weight to obtain the loss function.

The third preset threshold is 0.01-0.05.

By using the LR2-SR2 data set obtained by performing inference on the low-resolution image LR2 using the first model, a second model is trained, so that the second model can quickly approach the first model through, thereby quickly learning the generalization ability of the first model. The second model may be an image super-resolution model with a simple structure.

### Example 4

An image super-resolution model, obtained by training the second model by the method in Example 3, wherein the second model is an ECBSR model.

By using the LR2-SR2 data set obtained by performing inference on the low-resolution image LR2 using the first model, a second model is trained. Even if the structure of the second model is relatively simple, the second model can quickly approach the first model, thereby quickly learning the generalization ability of the first model. The trained second model has strong generalization ability, so it can use a smaller model structure to deal with low-resolution image problems caused by various reasons in real situations, repair and perform super-resolution on the above images with good super-resolution results.

In embodiments of the present disclosure, the method for generating an image super-resolution data set, the model training method, and the model of the present disclosure can be used in end-side models for training and learning. It can be understood that the methods and models are not limited to the above-mentioned applications, and can be used in all application scenarios that need to improve model generalization ability and improve model training efficiency.

The above are only preferred embodiments of the present disclosure and are not intended to limit the present disclosure. Any modifications, equivalent substitutions or improvements made within the spirit and principles of the present disclosure shall be included in the protection scope of the present disclosure.

1. A method for generating an image super-resolution data set, comprising steps of:
S101: constructing a high-resolution image set;
S102: performing image blind degradation processing on high-resolution image HR1 in the high-resolution image set to obtain the corresponding low-resolution image LR1 and thereby an LR1-HR1 data pair, and performing image blind degradation processing on all high-resolution images HR1 in the high-resolution image set to obtain an LR1-HR1 data set;
S103: training a first model with the LR1-HR1 data set to obtain a model parameter of the first model and saving the model parameter, wherein the first model is an image super-resolution model;
S104: constructing a low-resolution image set; and
S105: inputting low-resolution image LR2 in the low-resolution image set into the first model with the model parameter to obtain super-resolution image SR2 and thereby an LR2-SR2 data pair, and inputting all low-resolution images LR2 in the low-resolution image set into the first model with the model parameter to obtain an LR2-SR2 data set.

2. The method according to claim 1, wherein,
step S103 comprises:
S1031: inputting the low-resolution image LR1 into the first model, and the first model outputs super-resolution image SR1;
S1032: calculating a loss function using the high-resolution image HR1 and the super-resolution image SR1;
S1033: in the case where the loss function is less than a first preset threshold, saving the model parameter; and
S1034: repeating steps S1031 to S1033 for each LR1-HR1 data pair in the LR1-HR1 data set to obtain the model parameter of the first model.

3. The method according to claim 1, wherein,
the image blind degradation processing, based on a random selection method, comprises performing on the high-resolution image HR1 any one or more of:
blurring operation: based on the random selection method, selecting one or both of Gaussian blur and Sinc filter blur for operation;
scaling operation: based on the random selection method, selecting one or more of bilinear interpolation, bicubic interpolation, and regional interpolation for operation;
noise superposition operation: based on the random selection method, selecting one or both of Gaussian noise and Poisson noise for operation; and
image compression operation: compressing the image with a compression factor of 30%-95%; and
wherein, the image blind degradation processing is performed once, or the image blind degradation processing is iteratively performed twice.

4. The method according to claim 3, wherein,
the random selection method comprises randomly giving a random score between 0 and 1 to all options, and in the case where the random score of an option is less than a second preset threshold, the operation will not be performed; normalizing all random scores greater than or equal to the second preset threshold as a weight of the corresponding option, performing an operation corresponding to the options with the random score greater than or equal to the second preset threshold, and performing weighted calculation on the performed results of all options according to the weight to obtain an output result.

5. The method according to claim 1, wherein,
in step S103, the first model includes ESRGAN model, SwinIR model, and HAT model; and training the ESRGAN model, SwinIR model, and HAT model respectively with the LR1-HR1 data set and saving the model parameter of each model; and
in step S105, inputting low-resolution image LR2 into the ESRGAN model, SwinIR model, and HAT model respectively, and performing weighted fusion of the obtained results according to a preset weight to obtain the super-resolution image SR2;
wherein, the preset weight is 0.2 for the ESRGAN model, 0.4 for the SwinIR model, and 0.4 for the HAT model.

6. The method according to claim 1, wherein,
in steps S101-S102, the LR1-HR1 data set comprises n types of sub-training sets;
in step S103, training the first model comprises training the first model with n types of sub-training sets respectively to obtain n groups of sub-model parameter; and
in step S105, for the k groups of sub-model parameter, selecting one group of sub-model parameter in sequence as the model parameter of the first model, inputting the low-resolution image LR2 to obtain an output result, and performing weighted fusion of all output results according to a preset weight to obtain the super-resolution image SR2.

7. The method according to claim 1, wherein,
in steps S101-S102, the LR1-HR1 data set comprises one basic training set and k types of sub-training sets;
in step S103, training the first model with the basic training set to obtain a basic model parameter, and training the first model with the basic model parameter with k types of sub-training sets to obtain k groups of sub-model parameter; and
in step S105, for the k groups of sub-model parameter, selecting one group of sub-model parameter in sequence as the model parameter of the first model, inputting the low-resolution image LR2 to obtain an output result, and performing weighted fusion of all output results according to a preset weight to obtain the super-resolution image SR2.

8. An image super-resolution model training method, comprising training a second model with the LR2-SR2 data set obtained by the method according to claim 1, wherein the second model is an image super-resolution model, and the training methods comprises steps of:
S201: inputting the LR2 image into the second model, and the second model outputs SR2′ image;
S202: calculating a loss function using the super-resolution image SR2 and the super-resolution image SR2′, and in the case where the loss function is less than a third preset threshold, saving the model parameter; and
S203: repeating steps S201 to S202 for each LR2-SR2 data pair in the LR2-SR2 data set to obtain the model parameter of the second model.

9. The method according to claim 2, wherein,
the loss function is calculated by:
calculating L1 loss function, GAN loss function, and perceptual loss function respectively; and
performing weighted calculation on the above calculated results according to the preset weight to obtain the loss function.

10. An image super-resolution model, obtained by:
training the second model by the method according to claim 8, wherein the second model is an ECBSR model.
